(19) United States
(12) Patent Application Publication
(10) Pub. No.: US 2026/0180318 A1
(43) Pub. Date: Jun. 25, 2026

(54) AN INRUSH CURRENT LIMITING CIRCUIT ARRANGED FOR LIMITING AN INRUSH CURRENT TO A CAPACITOR, AS WELL AS CORRESPONDING POWER SUPPLY AND A METHOD

(71) Applicant: SIGNIFY HOLDING B.V., EINDHOVEN (NL)

(72) Inventors: TIJMEN CORNELIS VAN BODEGRAVEN, EINDHOVEN (NL); MOHAMMED AZOUMI, ROERMOND (NZ)

(21) Appl. No.: 19/128,189

(22) PCT Filed: Oct. 30, 2023
(86) PCT No.: PCT/EP2023/080174

§ 371 Date: May 8, 2025

(30) Foreign Application Priority Data
Nov. 10, 2022 (EP) 22206656.5

(51) Int. Cl. H02H 9/02; H02H 9/00

(52) U.S. Cl. CPC H02H 9/02; H02H 9/001

(57) ABSTRACT

An inrush current limiting circuit arranged for limiting an inrush current to a capacitor, comprising a controllable current limiting device arranged to be connected in series with said capacitor, wherein an impedance of said current limiting device is controllable and control circuitry arranged for controlling said impedance of said controllable current limiting device based on a voltage over said capacitor and based on said inrush current to said capacitor.

### TECHNICAL FIELD

The present disclosure generally relates to the field of inrush currents and, more specifically, to a method for effectively limiting the inrush current.

### BACKGROUND

The inrush current may be defined as the current that is drawn by an electrical device when it is first turned on. The inrush current may rise to high levels, given that different kinds of capacitors or the like need to be charged. A high inrush current is typically undesired as it may cause gradual damage to components and it may blow fuses or trip circuit breakers.

The above is, for example, the case for a bus capacitor. A power supply may convert a mains supply voltage to a Direct Current, DC, voltage. The DC voltage is then provided to a bus, wherein a capacitor is connected to the bus for a variety of reasons. One of the reasons is to generate a steady bus voltage.

Once the power supply turns on, an inrush current may be generated for charging that particular bas capacitor. Initially, the bus capacitor is completely discharged such that a relatively high inrush current may be provided to the bus capacitor.

Different types of inrush current limiting circuits are already known. One of the implementations relates to the use of a resistor in series connection with the output of the power supply. This would mean that the inrush current needs to pass the resistor, thereby effectively establishing a limiting factor for the inrush current.

Such an approach is not very efficient, especially in high-power devices, since the resistor will have a voltage drop and dissipate some power. This reduces the efficiency of the whole power supply/electrical device.

Inrush current can also be reduced by a Negative temperature coefficient, NTC, thermistor. NTC thermistors are commonly used in switching power supplies, motor drives and audio equipment to prevent damage caused by inrush current. A thermistor is a thermally-sensitive resistor with a resistance that changes significantly and predictably as a result of temperature changes. The resistance of an NTC thermistor decreases as its temperature increase.

It is a drawback of the known methods that they are not efficiently limiting the inrush current to desired amounts.

### SUMMARY

It is an object of the present disclosure to provide for an inrush current limiting circuit arranged for limiting an inrush current to a capacitor, for example a bus capacitor. It is a further object of the present disclosure to provide for a corresponding method and a corresponding power supply.

In a first aspect of the present disclosure, there is provided an inrush current limiting circuit arranged for limiting an inrush current to a capacitor, comprising:
a controllable current limiting device arranged to be connected in series with said capacitor, wherein an impedance of said current limiting device is controllable;
control circuitry arranged for controlling said impedance of said controllable current limiting device based on a voltage over said capacitor and based on said inrush current to said capacitor.

The inventors have found that it is beneficial if the current limiting device is controlled based on the voltage over the capacitor in combination with the inrush current to the capacitor.

Typical prior art solutions control the inrush current on one dimension. That is, they focus on the amount of inrush current and would like to prevent the inrush current to exceed a certain threshold value.

The inventors have found that this may not be the most beneficial way to limit the inrush current. The amount of acceptable inrush current may depend on the voltage over the capacitor. A relatively high inrush current is acceptable whenever the voltage over the capacitor is low, while a relatively low inrush current is desired whenever the voltage over the capacitor is high.

One of the benefits of the present disclosure is that the inrush current limiting circuit may control the inrush current based on the total amount of energy provided to the capacitor instead of regulating just based on the instantaneous amount of current provided to the capacitor.

In an example, said control circuitry is arranged for controlling said impedance of said controllable current limiting device based on said voltage over said capacitor and based on said inrush current to said capacitor such that a total amount of energy provided to said capacitor is relatively constant over time.

It was found that it may be beneficial to control, or limit, the amount of energy provided to the capacitor instead of actually controlling, limiting, the inrush current itself.

The total amount of energy provided to the capacitor depends on the voltage over the capacitor as well as the current at which the capacitor is charged. By controlling the current limiting device on both aspects, a control on the total amount of energy may be realized.

In an example, the control circuitry further comprises:
a current sense circuit arranged for providing a measure for said inrush current;
a voltage measurement circuit arranged for providing a measure of said voltage over said capacitor;
wherein said control circuitry is arranged for controlling said impedance of said controllable current limiting device based on said measure for said inrush current and said measure of said voltage over said capacitor.

The control circuitry controls the current limiting device based on the inrush current and the voltage over the capacitor. This example provides for an efficient implementation of actually realizing this. Typically, the measure for the inrush current is a voltage signal. A voltage drop over a resistor through which the inrush current flows, is representative for the actual inrush current itself. That particular voltage drop may be used as the measure for the inrush current.

The measure of the voltage over the capacitor may be determined in several ways. In accordance with the present disclosure, the bus capacitor may be connected in series with the current limiting device. The current limiting device may be connected to ground.

The measure for the voltage over the capacitor may be determined by actually measuring the voltage over the capacitor, but may also be determined by measuring the voltage over the current limiting device. Both options are viable and in line with the present disclosure.

In a further example, the control circuitry comprises:
an operational amplifier circuit arranged for receiving said measure for said inrush current and said measure of said voltage over said capacitor, and wherein an output of said operational amplifier controls said impedance of said controllable current limiting device.

Preferably, the operational amplifier circuit comprises an integrator circuit, for providing said output being proportional to a difference over time between said measure for said inrush current and said measure of said voltage over said capacitor.

The integrator circuit may be designed in such a way that it integrates two currents or that it integrates two voltages. Both options are viable, and covered by the present disclosure. It is preferred to integrate two voltages using a operational amplifier given that this is a more efficient solution, especially considering that, preferably, the output signal is a voltage for controlling the current limiting device.

In a further example, the integrator circuit is arranged to receive said measure for said inrush current at an inverting input of said integrator circuit and arranged to receive said measure for said voltage over said capacitor at a non-inverting input of said integrator circuit.

In another example, the controllable current limiting device is a Metal Oxide Semiconductor, MOS, Field Effect Transistor, FET, MOSFET.

In a second aspect of the present disclosure, there is provided a power supply arranged for providing a Direct Current, DC, voltage at a bus, said power supply comprising:
an inrush current limiting circuit in accordance with any of the previous claims, and
said capacitor connected in series with said controllable current limiting device.

It is noted that the advantages as explained with reference to the first aspect of the present disclosure, being the inrush current limiting circuit are also applicable to the second aspect of the present disclosure, being the power supply comprising such an inrush current limiting circuit.

In an example, the power supply further comprises:
a mains filter arranged for connecting to a mains supply;
a rectifier connected to an output of said mains filter, and
a Power Factor Correction, PFC, circuit connected to an output of said bridge rectifier, wherein an output of said PFC circuit is connected to said capacitor.

In a third aspect of the present disclosure, there is provided a method of controlling an inrush current limiting circuit in accordance with any of the previous examples, wherein said method comprises the step of:
controlling, by said control circuitry, said impedance of said controllable current limiting device based on a voltage over said capacitor and based on said inrush current to said capacitor.

It is noted that the advantages as explained with reference to the first aspect of the present disclosure, being the inrush current limiting circuit are also applicable to the third aspect of the present disclosure, being the method of controlling an inrush current limiting circuit.

In an example, the control circuitry further comprises a current sense circuit arranged for providing a measure for said inrush current and a voltage measurement circuit arranged for providing a measure of said voltage over said capacitor, wherein said method comprises the step of:
controlling, by said control circuitry, said impedance of said controllable current limiting device based on said measure for said inrush current and said measure of said voltage over said capacitor.

In a further example, the control circuitry comprises an operational amplifier circuit arranged for receiving said measure for said inrush current and said measure of said voltage over said capacitor, and wherein an output of said operational amplifier controls said impedance of said controllable current limiting device.

In yet another example, the operational amplifier circuit comprises an integrator circuit for providing said output being proportional to a difference over time between said measure for said inrush current and said measure of said voltage over said capacitor.

In an example, the integrator circuit is arranged to receive said measure for said inrush current at an inverting input of said integrator circuit and arranged to receive said measure for said voltage over said capacitor at a non-inverting input of said integrator circuit.

In a fourth aspect of the present disclosure, there is provided a computer program product comprising a computer readable medium having instructions stored thereon which, when executed by a control circuitry, cause said control circuitry to implement a method in accordance with any of the examples provided above.

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

In a further example, a lighting system is provided. The lighting system comprises a power supply and a light source.

The power supply has the inrush current limiter and the capacitor. The lighting system also has a light source that is powered by the power supply.

The above and other aspects of the disclosure will be apparent from and elucidated with reference to the examples described hereinafter.

### BRIEF DESCRIPTION OF THE DRAWINGS

FIG. 1 discloses an example of an inrush current limiting circuit in accordance with the present disclosure;

FIG. 2 discloses an example of an implementation of an inrush current limiting circuit in accordance with the present disclosure;

FIG. 3 discloses a typical example of a voltage, current and power diagram related to the controllable current limiting device.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the manner in which the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

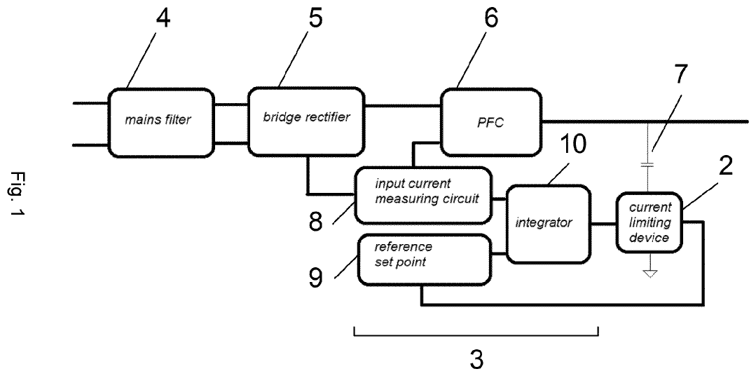

FIG. 1 discloses an example 1 of an inrush current limiting circuit in accordance with the present disclosure.

The inrush current limiting circuit comprises a controllable current limiting device 2 and a control circuitry 3 arranged for controlling the current limiting device 2. The operating principle is discussed here below. The control circuitry 3 comprises the input current measuring circuit 8, the reference set point module 9 and the integrator 10.

The inrush current limiting circuit is embodied in a power supply, wherein the power supply comprises a mains filter 4, a bridge rectifier 5, a Power Factor Correction, PFC, module 6 and a bus capacitor 7.

The mains filter 4 may comprise common mode filtering components, for example, to limit any common mode disturbances. Further, the mains filter may comprise filtering components to attenuate any flickering, on the mains supply line, or the like.

The bridge rectifier 5 is arranged to convert an Alternating Current, AC, voltage to a Direct Current, DC, voltage. The bridge rectifier may be implemented using a couple of diodes, in the form of a diode rectifier.

The Power Factor Correction, PFC, module 6 is arranged to improve the efficiency of the distribution system to which it is attached. The power factor is considered the ratio of the real power absorbed by any load to the apparent power flowing in the circuit.

The current limiting device 2 is connected in series to the bus capacitor. The impedance of the current limiting device 2 may be controlled, thereby effectively controlling the inrush current flowing to the bus capacitor 7.

In accordance with the present disclosure, the control circuitry may be arranged for controlling the impedance of said controllable current limiting device based on said voltage over said capacitor and based on said inrush current to said capacitor such that a total amount of energy provided to said capacitor is relatively constant over time.

The input current measuring circuit 8, i.e. the current sense circuit, is arranged to provide measure for the inrush current, and to provide that measure to the integrator 10.

The reference set point module 9, i.e. the voltage measurement circuit, is arranged for providing a measure of said voltage over said capacitor, and to provide that measure to the integrator 10.

The integrator 10 is arranged to receive said measure for said inrush current at an inverting input of said integrator circuit and arranged to receive said measure for said voltage over said capacitor at a non-inverting input of said integrator circuit. The output of the integrator 10 is used for controlling the controllable current limiting device 2.

The current limiting device 2 may, for example, be a Metal Oxide Semiconductor, MOS, Field Effect Transistor, FET, MOSFET.

A MOSFET is a voltage driven component making it more efficient to drive. The gate voltage may have a tolerance of about 20%-40% with a dependency on the temperature. The output voltage range of the integrator 10 may be around 0V till 10V to give no issues with high input current. The losses in the switch are given by the R_{dson}, in case of charging the bus capacitor 7, and by the body diode when the bus capacitor discharges 7.

A MOSFET may be advantageous as the MOSFET is able to operate as an impedance controlled switch, having a very low dissipation if required.

Charging the bus capacitor 7 may require several milliseconds. This time depend on the value of the bus capacitor 7, the voltage level and the inrush current. This current is what is to be limited, but the maximum duration may be limited by the specification of the start-up time of the power supply. During the charging of the bus capacitor 7, a current is flowing through the MOSFET and a voltage is across the MOSFET. This means during the charge time there may be a relative “high” power dissipation in the MOSFET.

The inventors have also found that the total amount of energy provided to the bus capacitor 7 may exceed a certain threshold for a certain pulse length. Increasing the pulse length will decrease the maximum total allowed exceedance of the threshold.

As such, the control circuitry may further control the controllable current limiting device based on the time duration of the total amount of energy provided to the bus capacitor 7, which may be represented by the total amount of current provided to the bus capacitor. This is accomplished by using the integrator 10.

In essence, with a short pulse a higher power is allowed to be dissipated by the MOSFET.

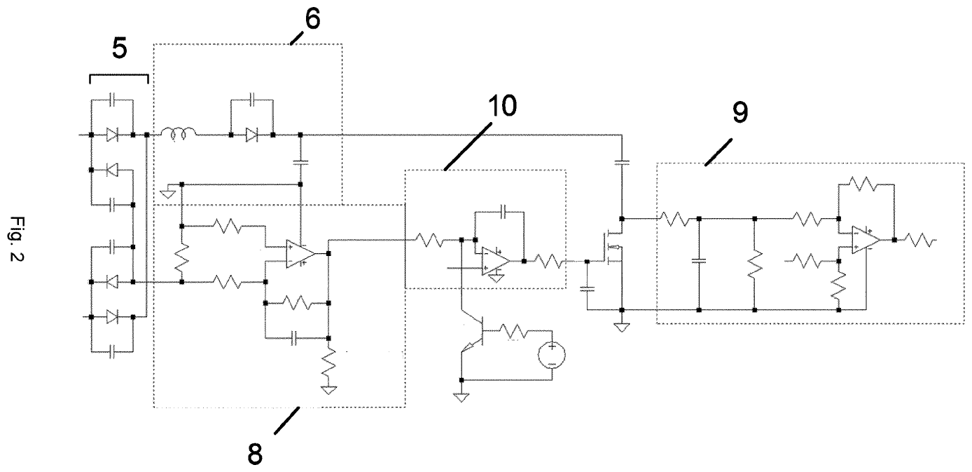

FIG. 2 discloses an example of an implementation 21 of an inrush current limiting circuit in accordance with the present disclosure.

The reference set point circuit 9 takes the voltage at the drain of the MOSFET as an input, and provide this via “out1” to the non-inverting input of the integrator 10.

The input current measuring circuit 8 comprises a sensing resistor 22, wherein a voltage over the sensing resistor 22 is used as a measure for the inrush current that flows to the bus capacitor 7. The output of the measuring circuit 8 is provided to the inverting input of the integrator 10.

The output of the integrator 10 is connected to the gate of the MOSFET, for controlling the impedance of the MOSFET.

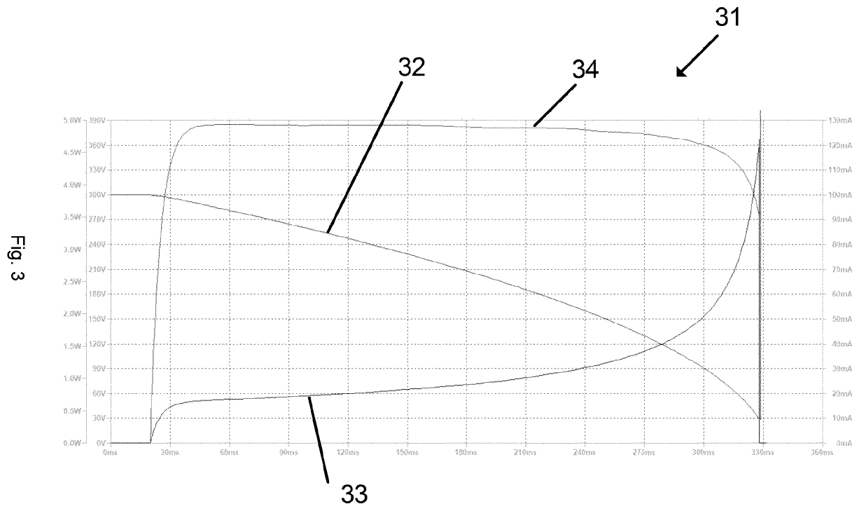

FIG. 3 discloses a typical example 31 of a voltage 32, current 33 and power 34 diagram related to the controllable current limiting device.

In accordance with the present disclosure, the total amount of energy, i.e. the power, that is provided to the bus capacitor 7 may be controlled. The power can be controlled by taking into account the voltage over the bus capacitor 7 as well as the inrush current.

The inrush current is depicted with reference numeral 33, the voltage over the MOSFET is depicted with reference numeral 32 and the power is depicted by reference numeral 34. As shown, the total amount of energy, i.e. power, provided to the bus capacitor 7 is relatively constant due to the concept that the control circuitry takes into account the voltage as well as the current. Preferably, the total amount of energy, i.e. power, provided to the bus capacitor 7 is relatively constant during at least a part of the inrush event. It is noted that the voltage over the MOSFET is inversely proportional to the voltage over the bus capacitor 7.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

Any reference signs in the claims should not be construed as limiting the scope thereof.

1. An inrush current limiting circuit arranged for limiting an inrush current to a capacitor, comprising:
a controllable current limiting device arranged to be connected in series with said capacitor, wherein an impedance of said current limiting device is controllable;
control circuitry arranged for controlling said impedance of said controllable current limiting device based on a voltage over said capacitor and based on said inrush current to said capacitor,
wherein said control circuitry is arranged for controlling said impedance of said controllable current limiting device based on said voltage over said capacitor and based on said inrush current to said capacitor such that a total amount of energy provided to said capacitor is relatively constant during at least a part of an inrush event.

2. An inrush current limiting circuit in accordance with claim 1, wherein said control circuitry further comprises:
a current sense circuit arranged for providing a measure for said inrush current;
a voltage measurement circuit arranged for providing a measure of said voltage over said capacitor;
wherein said control circuitry is arranged for controlling said impedance of said controllable current limiting device based on said measure for said inrush current and said measure of said voltage over said capacitor.

3. An inrush current limiting circuit in accordance with claim 2, wherein said control circuitry comprises:
an operational amplifier circuit arranged for receiving said measure for said inrush current and said measure of said voltage over said capacitor, and wherein an output of said operational amplifier controls said impedance of said controllable current limiting device.

4. An inrush current limiting circuit in accordance with claim 3, wherein said operational amplifier circuit comprises an integrator circuit, for providing said output being proportional to a difference over time between said measure for said inrush current and said measure of said voltage over said capacitor.

5. An inrush current limiting circuit in accordance with claim 4, wherein said integrator circuit is arranged to receive said measure for said inrush current at an inverting input of said integrator circuit and arranged to receive said measure for said voltage over said capacitor at a non-inverting input of said integrator circuit.

6. An inrush current limiting circuit in accordance with claim 1, wherein said controllable current limiting device is a Metal Oxide Semiconductor, MOS, Field Effect Transistor, FET, MOSFET.

7. A power supply arranged for providing a Direct Current, DC, voltage at a bus, said power supply comprising:
the inrush current limiting circuit in accordance with claim 1, and
said capacitor connected in series with said controllable current limiting device.

8. A power supply in accordance with claim 7, wherein said power supply further comprises:
a mains filter arranged for connecting to a mains supply;
a rectifier connected to an output of said mains filter, and
a Power Factor Correction, PFC, circuit connected to an output of said bridge rectifier, wherein an output of said PFC circuit is connected to said capacitor.

9. A method of controlling an inrush current limiting circuit for limiting an inrush current to a capacitor, the capacitor comprising a controllable current limiting device arranged to be connected in series with said capacitor, wherein an impedance of said current limiting device is controllable; and a control circuitry arranged for controlling said impedance of said controllable current limiting device based on a voltage over said capacitor and based on said inrush current to said capacitor, wherein said method comprises:
controlling, by said control circuitry, said impedance of said controllable current limiting device based on a voltage over said capacitor and based on said inrush current to said capacitor such that a total amount of energy provided to said capacitor is relatively constant during at least a part of an inrush event.

10. (canceled)

11. A method in accordance with claim 9, wherein said control circuitry further comprises a current sense circuit arranged for providing a measure for said inrush current and a voltage measurement circuit arranged for providing a measure of said voltage over said capacitor, wherein said method comprises:
controlling, by said control circuitry, said impedance of said controllable current limiting device based on said measure for said inrush current and said measure of said voltage over said capacitor.

12. A method in accordance with claim 11, wherein said control circuitry comprises an operational amplifier circuit arranged for receiving said measure for said inrush current and said measure of said voltage over said capacitor, and wherein an output of said operational amplifier controls said impedance of said controllable current limiting device.

13. A method in accordance with claim 12, wherein said wherein said operational amplifier circuit comprises an integrator circuit for providing said output being proportional to a difference over time between said measure for said inrush current and said measure of said voltage over said capacitor.

14. A lighting system comprising a power supply according to claim 7.
